(19) United States
(12) Patent Application Publication
(10) Pub. No.: US 2026/0229785 A1
(43) Pub. Date: Aug. 6, 2026

(54) ELECTRONIC DEVICE

(71) Applicant: HUAWEI TECHNOLOGIES CO., LTD., Shenzhen (CN)

(72) Inventors: Fei Xiang, Xi'an (CN); Liang Lu, Xi'an (CN); Tao Wang, Shenzhen (CN)

(73) Assignee: HUAWEI TECHNOLOGIES CO., LTD., Shenzhen (CN)

(21) Appl. No.: 19/632,079

(22) Filed: Mar. 27, 2026

Related U.S. Application Data
(63) Continuation of application No. PCT/CN2024/119412, filed on Sep. 18, 2024.

(30) Foreign Application Priority Data
Sep. 27, 2023 (CN) 202311272754.8

(51) Int. Cl. H01Q 13/10; H01Q 1/24; H01Q 1/48

(52) U.S. Cl. CPC H01Q 13/103; H01Q 1/241; H01Q 1/48; H01Q 13/106

(57) ABSTRACT

An antenna includes the radiator, the subboard, a first electronic element, a first connecting member, and a second connecting member. The radiator includes a first connection point and a second connection point, a first end of the first connecting member is electrically connected to the first connection point, and a first end of the second connecting member is electrically connected to the second connection point. The first electronic element is located on the subboard, and the first electronic element is electrically connected between a second end of the first connecting member and a second end of the second connecting member. The radiator is provided with a first slot between the first connection point and the second connection point.

### CROSS-REFERENCE TO RELATED APPLICATIONS

This application is a continuation of International Application No. PCT/CN2024/119412, filed on Sep. 18, 2024, which claims priority to Chinese Patent Application No. 202311272754.8, filed on Sep. 27, 2023. The disclosures of the aforementioned applications are hereby incorporated by reference in their entireties.

### TECHNICAL FIELD

This application relates to the field of wireless communication, and in particular, to an electronic device.

### BACKGROUND

As people have an increasing requirement for high-speed data transmission, a development trend of an industrial design (ID) of an electronic device is to have a large screen-to-body ratio and a plurality of cameras. Consequently, antenna clearance is greatly reduced, and space for layout is increasingly limited.

In a current context, in terms of a communication frequency band of the electronic device, a third generation (3G) mobile communication technology, a fourth generation (4G) mobile communication technology, and a fifth generation (5G) mobile communication technology may coexist for long time, and frequency band coverage is increasingly wide. Based on these changes, efficiency improvement of an antenna on an electronic device becomes a top priority.

### SUMMARY

This application provides an electronic device, including an antenna. The antenna includes a radiator and a subboard. System efficiency and radiation efficiency of the antenna can be improved by using an electronic element disposed on a surface of the subboard and a slit disposed on the radiator.

According to a first aspect, an electronic device is provided, including: a ground; and an antenna, including a radiator, a subboard, a first electronic element, a first connecting member, and a second connecting member. The subboard and the radiator are opposite to and not in contact with each other. The radiator includes a first connection point and a second connection point, a first end of the first connecting member is electrically connected to the first connection point, and a first end of the second connecting member is electrically connected to the second connection point. The first electronic element is located on the subboard, and the first electronic element is electrically connected between a second end of the first connecting member and a second end of the second connecting member. The radiator is provided with a first slot between the first connection point and the second connection point.

According to embodiments of this application, the first slot with which the radiator is provided may be considered as an equivalent capacitor (for example, a distributed capacitor) disposed on the radiator. The equivalent capacitor may enable the radiator to form a metamaterial structure. A radiation aperture of the radiator in the metamaterial structure may be increased, and after the first slot is provided, an electric field is more dispersed, and a dielectric loss near a conductor is reduced. Therefore, system efficiency and radiation efficiency of the antenna can be effectively improved.

With reference to the first aspect, in some implementations of the first aspect, the antenna further includes a third connecting member and a second electronic element, a first end of the third connecting member is electrically connected to the ground, the second electronic element is located on the subboard, and the second electronic element is electrically connected between the second end of the first connecting member and a second end of the third connecting member.

According to embodiments of this application, the second electronic element is added to the subboard, so that when the radiator generates a resonance, a current on the radiator is shunted in an area near the first connection point. Because shunt occurs in the area near the first connection point, current density on the radiator can be dispersed. Current distribution of the radiator is scattered, to reduce a conductor loss of the radiator. Current distribution of the radiator is scattered, to increase the radiation aperture of the radiator. Because the conductor loss of the radiator is reduced, and a radiation aperture of the antenna is increased, the system efficiency and the radiation efficiency of the antenna can be improved.

With reference to the first aspect, in some implementations of the first aspect, the electronic device further includes a side frame, the side frame includes a first location and a second location, the side frame is coupled and connected to the ground at the first location, and the side frame is provided with a second slot at the second location. The radiator is a conductor part of the side frame between the first location and the second location.

According to embodiments of this application, a first end (at the first location) of the radiator is a ground end, and a second end (at the second location) of the radiator is an open end. The radiator may operate in a quarter-wavelength mode. Based on the second electronic element and the first slot, an electrical length of the radiator may be increased from a quarter of a first wavelength to more than three-eighths of the first wavelength, but the radiator still operates in the quarter-wavelength mode. In this case, increasing the radiation aperture can effectively improve the system efficiency and the radiation efficiency of the antenna.

With reference to the first aspect, in some implementations of the first aspect, the electronic device includes a middle frame and a battery, the middle frame includes a battery compartment and a middle plate, the battery is located in space enclosed by the battery compartment, the battery compartment is located on the middle plate, and the middle plate is used as the ground. The subboard is located in a groove enclosed by a first part of the battery compartment, the radiator, and the middle plate.

With reference to the first aspect, in some implementations of the first aspect, the electronic device further includes a first metal member, a second metal member, and a third metal member. The first metal member, the second metal member, and the third metal member are located in the groove. A first part of the first metal member is welded to the middle plate, and a second part of the first metal member is located between the first end of the first connecting member and the first connection point. A first part of the second metal member is welded to the middle plate, and a second part of the second metal member is located between the first end of the second connecting member and the second connection point. A first part of the third metal member is welded to the middle plate, and a second part of the third metal member is located between the first end of the third connecting member and the first part of the battery compartment.

According to embodiments of this application, conductivity of the first metal member, the second metal member, or the third metal member may be greater than conductivity of the conductor part (for example, the radiator) of the side frame, the battery compartment, or the middle plate, to improve conductivity effect between the subboard and the radiator or the battery compartment, and improve stability of an electrical connection.

In addition, because a width of the groove enclosed by the first part of the battery compartment, the radiator, and the middle plate is narrow (for example, a distance between the first part of the battery compartment and the radiator is less than or equal to 3 mm), the first metal member, the second metal member, and the third metal member cannot be fastened to the first connection point, the battery compartment, and the second connection point through welding (for example, spot welding). Therefore, the foregoing technical solution may be used to weld (for example, perform spot welding on) the first metal member, the second metal member, and the third metal member to the middle plate, so that same technical effect can also be achieved and implementation is more convenient.

With reference to the first aspect, in some implementations of the first aspect, the first metal member, the second metal member, and the third metal member are springs. The first end of the first connecting member is elastically connected to the second part of the first metal member, the first end of the second connecting member is elastically connected to the second part of the second metal member, and the first end of the third connecting member is elastically connected to the second part of the third metal member.

According to embodiments of this application, a connecting member may fasten a second part of a corresponding metal member between a first end of the connecting member and a connection point in an elastic connection manner.

With reference to the first aspect, in some implementations of the first aspect, the electronic device further includes a limiting member, and the limiting member, the first part of the battery compartment, the radiator, and the middle plate form enclosed space.

According to embodiments of this application, the limiting member may be configured to limit the subboard to be located in the enclosed space, to prevent the subboard from sliding in the groove.

With reference to the first aspect, in some implementations of the first aspect, the first electronic element is located on a first surface or a second surface of the subboard, the first surface is a surface that is of the subboard and that faces the radiator, and the second surface is a surface that is of the subboard and that faces the battery compartment. The second electronic element is located on the first surface or the second surface.

According to embodiments of this application, different from a manner in which a circuit board is perpendicular to a radiator in the conventional technology, in embodiments of this application, a manner in which the subboard is parallel to the radiator is used, that is, the subboard is vertically inserted into a slot between the battery compartment and the radiator. In other words, when the slot is small, the subboard can still complete an electrical connection between the radiator and the circuit board.

With reference to the first aspect, in some implementations of the first aspect, the distance between the first part of the battery compartment and the radiator is less than or equal to 3 mm.

With reference to the first aspect, in some implementations of the first aspect, a length of a conductor part between the first location and the first slot is less than a length of a conductor part between the second location and the first slot.

With reference to the first aspect, in some implementations of the first aspect, the length of the conductor part between the first location and the first slot is less than three-fifths of the length of the conductor part between the second location and the first slot.

According to embodiments of this application, the first slot may be located in an area, of the radiator, with a large current. The area with a large current should be understood as that in comparison with a radiator (for example, operating in the quarter-wavelength mode) that is not slotted, after the first slot is provided, strength of an electric field of the radiator is weakened, to disperse the electric field. This improves the system efficiency and the radiation efficiency of the antenna.

With reference to the first aspect, in some implementations of the first aspect, the side frame includes a first side and a second side that intersect at an angle, and a length of the first side is greater than a length of the second side. The first slot is located on the first side, and a distance between the first slot and a midpoint of the first side is greater than 0 mm and less than or equal to 30 mm.

According to embodiments of this application, the first slot does not overlap the midpoint of the first side, so that strength of the electronic device can be improved.

With reference to the first aspect, in some implementations of the first aspect, the side frame includes the first side and a third side that intersect with the second side at an angle, lengths of the first side and the third side are greater than the length of the second side, and the first slot or the second slot is located on the first side. The side frame is provided with a third slot on the third side, a distance between the first slot or the second slot and the third slot in a first direction is greater than or equal to 2 mm, and the first direction is an extension direction of the first side.

According to embodiments of this application, the first slot and the second slot do not overlap the third slot in the extension direction of the first side, so that the strength of the electronic device can be improved.

With reference to the first aspect, in some implementations of the first aspect, a distance between the third slot and a midpoint of the third side is greater than 0 mm and less than or equal to 30 mm.

According to embodiments of this application, the third slot does not overlap the midpoint of the third side, so that the strength of the electronic device can be improved.

With reference to the first aspect, in some implementations of the first aspect, a length of a radiator between the first connection point and the first slot is less than or equal to 5 mm; and/or a length of a radiator between the second connection point and the first slot is less than or equal to 5 mm.

According to embodiments of this application, an equivalent capacitance value of the first slot may be adjusted via the first electronic element electrically connected between the first connection point and the second connection point, to adjust a radiation characteristic (for example, a resonance point frequency) of the antenna.

With reference to the first aspect, in some implementations of the first aspect, a size of the subboard in a second direction is less than or equal to 1 mm, a size of the subboard in a third direction is less than or equal to 5 mm, the second direction is a direction perpendicular to an extension direction of the subboard, and the third direction is a thickness direction of the electronic device.

According to a second aspect, an electronic device is provided, including: a ground; and an antenna, including a radiator, a subboard, a first electronic element, a first connecting member, and a second connecting member. The subboard and the radiator are opposite to and not in contact with each other. The radiator includes a first connection point, a first end of the first connecting member is electrically connected to the first connection point, and a first end of the second connecting member is electrically connected to the ground. The first electronic element is electrically connected between a second end of the first connecting member and a second end of the second connecting member. The first electronic element is located on a first surface or a second surface of the subboard, the first surface is a surface that is of the subboard and that faces the radiator, and the second surface is a surface that is of the subboard and that is opposite to the first surface.

According to embodiments of this application, the first electronic element is disposed on the subboard, so that when the radiator generates a resonance, a current on the radiator is shunted in an area near the first connection point. Because shunt occurs in the area near the first connection point, current density on the radiator can be dispersed. Current distribution of the radiator is scattered, to reduce a conductor loss of the radiator. Current distribution of the radiator is scattered, to increase a radiation aperture of the radiator. Because the conductor loss of the radiator is reduced, and a radiation aperture of the antenna is increased, system efficiency and radiation efficiency of the antenna can be improved. Different from a manner in which a circuit board is perpendicular to a radiator in the conventional technology, in embodiments of this application, a manner in which the subboard is parallel to the radiator is used, that is, the subboard is vertically inserted into a slot between a battery compartment and the radiator. In other words, when the slot is small, the subboard can still complete an electrical connection between the radiator and the circuit board.

With reference to the second aspect, in some implementations of the second aspect, the electronic device further includes a side frame, the side frame includes a first location and a second location, the side frame is coupled and connected to the ground at the first location, and the side frame is provided with a first slot at the second location. The radiator is a conductor part of the side frame between the first location and the second location.

With reference to the second aspect, in some implementations of the second aspect, the electronic device further includes a middle frame and a battery, the middle frame includes the battery compartment and a middle plate, the battery is located in space enclosed by the battery compartment, the battery compartment is located on the middle plate, and the middle plate is used as the ground. The subboard is located in a groove enclosed by a first part of the battery compartment, the radiator, and the middle plate.

With reference to the second aspect, in some implementations of the second aspect, the electronic device further includes a first metal member and a second metal member. The first metal member and the second metal member are located in the groove. A first part of the first metal member is welded to the middle plate, and a second part of the first metal member is located between the first end of the first connecting member and the first connection point. A first part of the second metal member is welded to the middle plate, and a second part of the second metal member is located between the first end of the second connecting member and the first part of the battery compartment.

According to embodiments of this application, conductivity of the first metal member and the second metal member may be greater than conductivity of the conductor part (for example, the radiator) of the side frame, the battery compartment, or the middle plate, to improve conductivity effect between the subboard and the radiator or the battery compartment, and improve stability of the electrical connection.

In addition, because a width of the groove enclosed by the first part of the battery compartment, the radiator, and the middle plate is narrow (for example, a distance between the first part of the battery compartment and the radiator is less than or equal to 3 mm), the first metal member and the second metal member cannot be fastened to the first connection point, the battery compartment, and the second connection point through welding (for example, spot welding). Therefore, the foregoing technical solution may be used to weld (for example, perform spot welding on) the first metal member and the second metal member to the middle plate, so that same technical effect can also be achieved and implementation is more convenient.

With reference to the second aspect, in some implementations of the second aspect, the first metal member and the second metal member are springs. The first end of the first connecting member is elastically connected to the second part of the first metal member, and the first end of the second connecting member is elastically connected to the second part of the second metal member.

According to embodiments of this application, a connecting member may fasten a second part of a corresponding metal member between a first end of the connecting member and a connection point in an elastic connection manner.

With reference to the second aspect, in some implementations of the second aspect, the electronic device further includes a limiting member, and the limiting member, the first part of the battery compartment, the radiator, and the middle plate form enclosed space.

According to embodiments of this application, the limiting member may be configured to limit the subboard to be located in the enclosed space, to prevent the subboard from sliding in the groove.

With reference to the second aspect, in some implementations of the second aspect, a size of the subboard in a second direction is less than or equal to 1 mm, a size of the subboard in a third direction is less than or equal to 5 mm, the second direction is a direction perpendicular to an extension direction of the subboard, and the third direction is a thickness direction of the electronic device.

### BRIEF DESCRIPTION OF DRAWINGS

FIG. 1 is a diagram of an electronic device 10 according to an embodiment of this application;

FIG. 2 is a diagram of an antenna 200 according to an embodiment of this application;

FIG. 3 is a diagram of an antenna 200 according to an embodiment of this application;

FIG. 4 is a diagram of an antenna 200 according to an embodiment of this application;

FIG. 5 is a diagram of an electronic device 10 according to an embodiment of this application;

FIG. 6 is a diagram of an electronic device 10 according to an embodiment of this application;

FIG. 7 is a diagram of an electronic device 10 according to an embodiment of this application;

FIG. 8A and FIG. 8B are diagrams of electronic devices 10 according to an embodiment of this application;

FIG. 9 is a diagram of an electronic device 10 according to an embodiment of this application; and

FIG. 10 is a diagram of an electronic device 10 according to an embodiment of this application.

### DESCRIPTION OF EMBODIMENTS

The following describes terms that may appear in embodiments of this application.

It should be understood that the term “and/or” used in this specification describes only a same field for describing associated objects, and indicates that three relationships may exist. For example, A and/or B may indicate the following three cases: Only A exists, both A and B exist, and only B exists. In addition, the character “/” in this specification generally indicates an “or” relationship between associated objects.

In this application, “within a range of . . . ” includes end values at both ends of the range by default. For example, in a range of 1 to 5, two values 1 and 5 are included.

Coupling: The coupling may be understood as direct coupling and/or indirect coupling, and a “coupling connection” may be understood as a direct coupling connection and/or an indirect coupling connection. The direct coupling may also be referred to as an “electrical connection”, and may be understood as physical contact and electrical conduction of components; or may be understood as a form in which different components in a line structure are connected through a physical line that may transmit an electrical signal, for example, a copper foil or a conductive wire of a printed circuit board (PCB). The “indirect coupling” may be understood as electrical conduction of two conductors through air or without contact. In an embodiment, the indirect coupling may also be referred to as capacitive coupling. For example, signal transmission is implemented by forming an equivalent capacitor through coupling in a gap between two spaced conductive members.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor including two conductive members that are spaced apart by a specific gap.

Inductor: The inductor may be understood as a lumped inductor and/or a distributed inductor. The lumped inductor is an inductive component, for example, an inductive element. The distributed inductor (or distributed type inductor) is an equivalent inductor including a conductive member with a specific length.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator via a feeder. The radiator converts the energy into polarized electromagnetic wave energy and radiates the energy in a required direction. A receive radiator converts polarized electromagnetic wave energy from a predefined direction of space into modulated high-frequency current energy, and transmits the modulated high-frequency current energy to an input end of a receiver via a feeder.

The radiator may include a conductor with a predefined shape and dimensions, for example, a linear radiator or a sheet-shaped radiator. A shape is not limited in this application. In an embodiment, the linear radiator may be referred to as a wire antenna for short. In an embodiment, the linear radiator may be implemented by a conductive side frame, and may also be referred to as a side frame antenna. In an embodiment, the linear radiator may be implemented by a support conductor, and may also be referred to as a support antenna. In an embodiment, a wire diameter (for example, including a thickness and a width) of the linear radiator or a radiator of the wire antenna is far less than a wavelength (for example, a dielectric wavelength) (for example, is less than 1/16 of the wavelength), and a length may be compared with the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include a dipole antenna, a half-wave dipole antenna, a monopole antenna, a loop antenna, and an inverted F antenna (IFA). For example, for the dipole antenna, each dipole antenna usually includes two radiation stubs, and each stub is fed by a feed portion from a feed end of the radiation stub. For example, the inverted F antenna (IFA) may be considered as being obtained by adding a ground path to a monopole antenna. The IFA has a feed point and a ground point, and is referred to as the inverted F antenna because a side view of the IFA is in an inverted F shape. In an embodiment, a sheet-shaped radiator may include a microstrip antenna, or a patch antenna, for example, a planar inverted F antenna (PIFA). In an embodiment, the sheet-shaped radiator may be implemented by a planar conductor (for example, a conductive sheet or a conductive coating). In an embodiment, the sheet-shaped radiator may include a conductive sheet, for example, a copper sheet. In an embodiment, the sheet-shaped radiator may include a conductive coating, for example, silver paste. The sheet-like radiator is in a shape of a circle, a rectangle, a loop, or the like. A shape is not limited in this application. A structure of the microstrip antenna usually includes a dielectric substrate, a radiator, and a ground, where the dielectric substrate is disposed between the radiator and the ground.

The radiator may also include a slot or a slit formed on a conductor, for example, a closed or semi-closed slot or slit formed on a grounded conductor surface. In an embodiment, a radiator with a slot or a slit may be referred to as a slot antenna or a slotted antenna for short. In an embodiment, a radial size (for example, including a width) of the slot or slit of the slot antenna/slotted antenna is far less than a wavelength (for example, a dielectric wavelength) (for example, is less than 1/16 of the wavelength), and a length size may be compared with the wavelength (for example, the dielectric wavelength) (for example, the length is approximately ⅛ of the wavelength, or ⅛ to ¼ of the wavelength, or ¼ to ½ of the wavelength, or greater). In an embodiment, a radiator with a closed slot or slit may be referred to as a closed slot antenna for short. In an embodiment, a radiator with a semi-closed slot or slit (for example, an opening is additionally provided on the closed slot or slit) may be referred to as an open slot antenna for short. In some embodiments, the slit is long strip-shaped. In some embodiments, a length of the slit is approximately half the wavelength (for example, the dielectric wavelength). In some embodiments, a length of the slit is approximately an integer multiple of the wavelength (for example, a one-fold dielectric wavelength). In some embodiments, the slit may be used for feeding through a transmission line bridged on one side or two sides of the slit. In this way, a radio frequency electromagnetic field is excited on the slit, and an electromagnetic wave is radiated to space. In an embodiment, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground and is grounded at two ends of the radiator, to form a closed or semi-closed slot or slit. In an embodiment, the radiator of the slot antenna or the slotted antenna may be implemented by a support conductor that is grounded at two ends, and may also be referred to as a support antenna.

A feed circuit is a combination of all circuits configured to receive and transmit radio frequency signals. The feed circuit may include a transceiver and a radio frequency front end circuit (RF front end). In some cases, in a narrow sense, the “feed circuit” is a radio frequency integrated circuit (RFIC), and the RFIC may be considered to include a radio frequency front end chip and the transceiver. The feed circuit has a function of converting a radio wave (for example, a radio frequency signal) and an electrical signal (for example, a digital signal). Usually, the feed circuit is considered as a part of radio frequency.

In some embodiments, an electronic device may further include a test base (which is also referred to as a radio frequency base or a radio frequency test base). A coaxial cable may be inserted into the test base, to test a characteristic of the radio frequency front end circuit or the radiator of the antenna through the cable. The radio frequency front end circuit may be considered as a circuit part coupled between the test base and the transceiver.

In some embodiments, the radio frequency front end circuit may be integrated into the radio frequency front end chip of the electronic device, or the radio frequency front end circuit and the transceiver may be integrated into the radio frequency integrated circuit of the electronic device.

It should be understood that any two of a first feed circuit, a second feed circuit, . . . , and an N^{th} feed circuit in this application may share a same transceiver, for example, transmit a signal through a radio frequency channel in the transceiver (for example, a pin of the radio frequency integrated circuit); and may further share a radio frequency front end, for example, process the signal via a switch or an amplifier in the radio frequency front end.

It should be further understood that two of the first feed circuit, the second feed circuit, . . . , and the N^{th} feed circuit in this application usually correspond to two radio frequency test bases of the electronic device.

A matching circuit is a circuit configured to adjust a radiation characteristic of an antenna. In an embodiment, the matching circuit is coupled between the feed circuit and a corresponding radiator. In an embodiment, the matching circuit is coupled between a test base and a radiator. Generally, the matching circuit is a combination of circuits coupled between the radiator and a ground. In an embodiment, the matching circuit may include a switch and/or an electronic element. The switch may be an electronic element configured to switch a coupling connection of the radiator. The matching circuit has a function of impedance matching and/or frequency tuning. Usually, the matching circuit is considered as a part of an antenna.

Ground structure/Feed structure: The ground structure/feed structure may include a connecting member, for example, a metal spring. A radiator is coupled and connected to a ground via the ground structure/coupled and connected to a feed circuit via the feed structure. In some embodiments, the feed structure may include a transmission line/feed line, and the ground structure may include a ground cable.

End/Point: An “end/point” in a first end/second end/feed end/ground end/feed point/ground point/connection point of an antenna radiator cannot be understood in a narrow sense as an endpoint or an end part that is physically disconnected from another radiator, and may also be considered as a point or a segment on a continuous radiator. In an embodiment, the “end/point” may include a connection/coupling area that is on the antenna radiator and that is coupled and connected to another conductive structure. For example, the feed end/feed point may be a coupling area that is on the antenna radiator and that is coupled and connected to a feed structure (for example, an area opposite to a part of the feed structure). For another example, the ground end/ground point may be a connection/coupling area that is on the antenna radiator and that is coupled and connected to the ground structure.

Open end and closed end: In some embodiments, the open end and closed end are defined based on whether the open end and the closed end are grounded, for example, the closed end is grounded, and the open end is not grounded. In some embodiments, the open end and the closed end are, for example, relative to another conductor. The closed end is electrically connected to the another conductor, and the open end is not electrically connected to the another conductor. In an embodiment, the open end may also be referred to as a floating end, a free end, an opening end or an open-circuit end. In an embodiment, the closed end may also be referred to as a ground end or a short-circuit end. It should be understood that, in some embodiments, another conductor may be coupled and connected via the open end, to transfer coupling energy (which may be understood as transferring a current).

In some embodiments, the “closed end” may also be understood from a perspective of current distribution. The closed end, the ground end, or the like may be understood as a point of maximum current on a radiator, or may be understood as a point of minimum electric field on a radiator. In an embodiment, the closed end is coupled to an electronic component (for example, a capacitor or an inductor), so that a current distribution characteristic of the point of maximum current/point of minimum electric field on the radiator may not be changed. In an embodiment, a slit (for example, a slot filled with an insulation material) at or near the closed end may not change a current distribution characteristic of the point of maximum current/point of minimum electric field of the radiator at the slit.

In some embodiments, the “open end” may also be understood from a perspective of current distribution. The open end, the floating end, or the like may be understood as a point of minimum current on a radiator, or may be understood as a point of maximum electric field on a radiator. In an embodiment, the open end is coupled to an electronic component (for example, a capacitor or an inductor), so that a current distribution characteristic of the point of minimum current/point of maximum electric field on the radiator may not be changed.

It should be understood that a radiator end (similar to a radiator at an opening of the open end or the floating end from a perspective of a radiator structure) in a slot is coupled to the electronic component (for example, the capacitor or the inductor), so that the radiator end is a point of maximum current/point of minimum electric field. In this case, it should be understood that the radiator end in the slot is actually a closed end, a ground end, or the like.

A “floating radiator” in embodiments of this application means that the radiator is not directly connected to a feed line/feed stub and/or a ground cable/ground stub, but is fed and/or grounded in an indirect coupling manner.

It should be understood that “floating” in the “floating end” and the “floating radiator” does not mean that there is no structure around the radiator to support the radiator. In an embodiment, the floating radiator may be, for example, a radiator provided on an inner surface of an insulation rear cover.

That currents are codirectional/reverse in embodiments of this application should be understood as that directions of main currents on conductors on a same side are the same or reverse. For example, when currents distributed in a same direction are excited on a bent conductor or an annular conductor (for example, a current path is also bent or annular), it should be understood that although main currents excited on conductors on two sides of the annular conductor (for example, on conductors around a slot, or on conductors on two sides of a slot) are in reverse directions, the main currents still meet definition of the currents distributed in a same direction in this application. In an embodiment, that currents on a conductor are in a same direction may mean that the currents on the conductor have no reverse point. In an embodiment, that currents on a conductor are in reverse directions may mean that the currents on the conductor have at least one reverse point. In an embodiment, that currents on two conductors are in a same direction may mean that none of the currents on the two conductors has a reverse point and the currents flow in the same direction. In an embodiment, that currents on two conductors are in reverse directions may mean that none of the currents on the two conductors has a reverse point and the currents flow in the reverse directions. It may be correspondingly understood that directions of currents on a plurality of conductors are codirectional/reverse.

Resonance/resonance frequency: The resonance frequency is also referred to as a resonant frequency. The resonance frequency may have a frequency range, that is, a frequency range in which a resonance occurs. A frequency corresponding to a strongest resonance point is a center frequency point frequency. A return loss of the center frequency may be less than −20 decibels (dB). It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna or the radiator may generate one or more antenna modes based on a design, and one fundamental mode resonance may be correspondingly generated in each antenna mode.

Resonance frequency band: A range of a resonance frequency is a resonance frequency band, and a return loss of any frequency on the resonance frequency band may be less than −6 dB or −5 dB.

Communication frequency band/Operating frequency band: Regardless of a type of antenna, the antenna constantly operates in a specific frequency range (a frequency band width). For example, an operating frequency band of an antenna supporting a B40 frequency band includes a frequency in a range of 2300 megahertz (MHz) to 2400 MHz. In other words, the operating frequency band of the antenna includes the B40 frequency band. A frequency range that meets a requirement of an indicator may be considered as an operating frequency band of an antenna.

A resonance frequency band and the operating frequency band may be the same, or may partially overlap. In an embodiment, one or more resonance frequency bands of an antenna may cover one or more operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} .$$

Lis the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (air wavelength or vacuum wavelength)=speed of light/frequency, where the frequency is a frequency (MHz) of the radiation signal, and the speed of light may be 3×10⁸ m/s. A wavelength of the radiation signal in a dielectric may be calculated as follows: dielectric wavelength=(speed of light/\sqrt{ε})/frequency, where ε is a relative dielectric constant of the dielectric. The wavelength in embodiments of this application is usually a dielectric wavelength, and may be a dielectric wavelength corresponding to a center frequency of a resonance frequency, or a dielectric wavelength corresponding to a center frequency of an operating frequency band supported by an antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated based on the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated based on a relative dielectric constant of a dielectric filled in one or more sides of a radiator.

Ground (GND): The ground may generally be at least a part of any ground layer, ground plane, ground metal layer, or the like of an electronic device (for example, a mobile phone), or at least a part of any combination of any ground layer, ground plane, ground part, or the like. The “ground” may be configured to ground a component of the electronic device. In an embodiment, the “ground” may be a ground layer of a circuit board of an electronic device, or may be a ground plane formed by a middle frame of an electronic device or a ground metal layer formed by a metal film below a screen of an electronic device.

Any ground layer, ground plane, or ground metal layer is made of a conductive material. In an embodiment, the conductive material may be any one of the following materials: copper, aluminum, stainless steel, brass and alloys thereof, copper foils on insulation laminates, aluminum foils on insulation laminates, gold foils on insulation laminates, silver-plated copper, silver-plated copper foils on insulation laminates, silver foils on insulation laminates and tin-plated copper, cloth impregnated with graphite powder, graphite-coated laminates, copper-plated laminates, brass-plated laminates, and aluminum-plated laminates. A person skilled in the art may understand that the ground layer/ground plane/ground metal layer may alternatively be made of another conductive material.

Grounding: The grounding is coupling to the ground/ground plane via a ground structure and/or a ground circuit. In an embodiment, grounding may be grounding via an entity, for example, grounding via an entity (or referred to as entity grounding) at a location on a side frame is implemented via some mechanical members of a middle frame. In an embodiment, the grounding may be grounding via a component, for example, grounding via a component (or referred to as component grounding) like a capacitor/inductor/resistor connected in series or in parallel.

The following describes technical solutions of embodiments in this application with reference to accompanying drawings.

As shown in FIG. 1, an electronic device 10 may include a cover 13, a display screen/display module (display) 15, a printed circuit board (PCB) 17, a middle frame 19, and a rear cover 21. It should be understood that, in some embodiments, the cover 13 may be cover glass, or may be replaced with a cover made of another material, for example, a cover made of a PET (polyethylene terephthalate) material.

The cover 13 may be tightly attached to the display module 15, and may mainly serve for protection and dust resistance of the display module 15.

In an embodiment, the display module 15 may include a liquid crystal display (LCD) panel, a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in an embodiment, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers dielectric board, or may be a hybrid dielectric board of Rogers and FR-4, or the like. Herein, FR-4 is a grade designation of a flame-resistant material, and the Rogers dielectric board is a high-frequency board. Electronic elements, for example, a radio frequency chip, are carried on the PCB 17. In an embodiment, a metal layer may be disposed on the printed circuit board PCB 17. The metal layer may be configured to ground the electronic element carried on the printed circuit board PCB 17, or may be configured to ground another element, for example, a support antenna or a side frame antenna. The metal layer may be referred to as a ground, a ground plane, or a ground layer. In an embodiment, the metal layer may be formed by etching metal on a surface of any dielectric board in the PCB 17. In an embodiment, the metal layer configured for grounding may be disposed on a side that is of the printed circuit board PCB 17 that is close to the middle frame 19. In an embodiment, an edge of the printed circuit board PCB 17 may be considered as an edge of the ground plane of the PCB 17. In an embodiment, the metal middle frame 19 may also be configured to ground the foregoing element. The electronic device 10 may further have another ground or the like as described above. Details are not described herein again.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a subboard. The battery may be disposed between the mainboard and the subboard. The mainboard may be disposed between the middle frame 19 and an upper edge of the battery, and the subboard may be disposed between the middle frame 19 and a lower edge of the battery.

The electronic device 10 may further include a side frame 11. The side frame 11 may be made of a conductive material like metal. The side frame 11 may be disposed between the display screen 15 and the rear cover 21, and extend around a periphery of the electronic device 10. The side frame 11 may have four sides surrounding the display screen 15, to help fasten the display screen 15.

In an implementation, the side frame 11 made of the conductive material may be directly used as a conductive side frame of the electronic device 10, for example, form an appearance of the metal side frame. This is applicable to metal industrial design (ID). In an implementation, an outer surface of the side frame 11 may be made of a conductive material, for example, a metal material, to form an appearance of a metal side frame. In these implementations, a conductive part of the side frame 11 may be used as an antenna radiator of the electronic device 10.

In another implementation, an outer surface of the side frame 11 may alternatively be made of a non-conductive material, for example, plastic, to form an appearance of a non-metal side frame, and this is applicable to a non-metal ID. In an implementation, an inner surface of the side frame 11 may include a conductive material, for example, a metal material. In this implementation, a conductive part of the side frame 11 may be used as the antenna radiator of the electronic device 10. It should be understood that the radiator disposed on the inner surface of the side frame 11 (namely, a conductive material on the inner surface) is attached to a non-conductive material of the side frame 11, to facilitate antenna radiation. Both the conductive material and the non-conductive material should be considered as a part of the side frame 11.

The middle frame 19 may include the side frame 11, and the middle frame 19 including the side frame 11 is used as an integrated member, and may support an electronic component in the entire device. The cover 13 and the rear cover 21 are respectively closed along an upper edge and a lower edge of the side frame, to form a casing or a housing of the electronic device. In an embodiment, the cover 13, the rear cover 21, the side frame 11, and/or the middle frame 19 may be collectively referred to as a casing or a housing of the electronic device 10. It should be understood that the “casing or housing” may mean a part or all of any one of the cover 13, the rear cover 21, the side frame 11, and the middle frame 19, or mean a part or all of any combination of the cover 13, the rear cover 21, the side frame 11, and the middle frame 19.

At least a part of the side frame 11 on the middle frame 19 may serve as a radiator of an antenna to transmit/receive a radio frequency signal. A gap may exist between the part of the side frame that serves as the radiator and another part of the middle frame 19, to ensure that the radiator of the antenna has a good radiation environment. In an embodiment, the middle frame 19 may be provided with an aperture at the part of the side frame that serves as the radiator, to facilitate radiation of the antenna.

Alternatively, the side frame 11 may not be considered as a part of the middle frame 19. In an embodiment, the side frame 11 may be connected to and integrally formed with the middle frame 19. In another embodiment, the side frame 11 may include a protruding member extending inward, to be connected to the middle frame 19, for example, connected via a spring or a screw, or connected through welding. The protruding member of the side frame 11 may be further configured to receive a feed signal, so that at least a part of the side frame 11 serves as a radiator of an antenna to receive/transmit a radio frequency signal. A gap 42 may exist between the middle frame 30 and the part of the side frame that serves as the radiator, to ensure that the radiator of the antenna has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material. In an embodiment, the rear cover 21 including the conductive material may replace the middle frame 19, and serves as an integrated part with the side frame 11, to support an electronic component in the entire device.

In an embodiment, the middle frame 19 and/or a conductive part of the rear cover 21 may serve as a reference ground of the electronic device 10. The side frame 11, the PCB 17, and the like of the electronic device may be electrically connected to the middle frame for grounding.

The antenna of the electronic device 10 may be further disposed in the side frame 11. When the side frame 11 of the electronic device 10 is made of a non-conductive material, the radiator of the antenna may be located in the electronic device 10 and disposed along the side frame 11. For example, the radiator of the antenna is disposed close to the side frame 11, to minimize a volume occupied by the radiator of the antenna, and is closer to the outside of the electronic device 10, to achieve better signal transmission effect. It should be noted that, that the radiator of the antenna is disposed close to the side frame 11 means that the radiator of the antenna may be tightly attached to the side frame 11, or may be disposed close to the side frame 11. For example, there may be a small slot between the radiator of the antenna and the side frame 11.

The antenna of the electronic device 10 may be further disposed in the casing, for example, a support antenna or a millimeter wave antenna (not shown in FIG. 1). Clearance of the antenna disposed in the housing may be obtained via a slit/hole in any one of the middle frame, and/or the side frame, and/or the rear cover, and/or the display screen, or via a non-conductive slot/aperture formed between any several of the middle frame, and/or the side frame, and/or the rear cover, and/or the display. The clearance of the antenna may be provided, to ensure radiation performance of the antenna. It should be understood that, the clearance of the antenna may be a non-conductive area including any conductive component in the electronic device 10, and the antenna radiates a signal to external space through the non-conductive area. In an embodiment, a form of the antenna 40 may be an antenna form based on a flexible mainboard or a flexible printed circuit (FPC), an antenna form based on laser direct structuring (LDS), an antenna form like a microstrip disk antenna (MDA), or the like. In an embodiment, the antenna may alternatively use a transparent structure embedded into a screen of the electronic device 10, so that the antenna is a transparent antenna element embedded into the screen of the electronic device 10.

FIG. 1 shows only an example of some parts included in the electronic device 10. Actual shapes, actual sizes, and actual structures of the parts are not limited to those in FIG. 1.

It should be understood that, in embodiments of this application, it may be considered that a surface on which the display screen of the electronic device is located is a front surface, a surface on which the rear cover is located is a rear surface, and a surface on which the side frame is located is a side surface.

It should be understood that, in embodiments of this application, it is considered that when a user holds the electronic device (for example, when the user holds the electronic device and unlocks the electronic device, or when the user holds the electronic device vertically and faces the screen), an orientation of the electronic device includes a top part, a bottom part, a left side part, and a right side part.

For indirect description, all antenna structures provided in embodiments of this application are wire antennas. During actual application, another antenna structure, for example, a patch antenna may be adopted. This is not limited in embodiments of this application.

An embodiment of this application provides an electronic device, including an antenna. The antenna includes a radiator and a subboard, and an electronic element on the subboard is electrically connected between the radiator and a ground via a connecting member, so that the antenna has a better radiation characteristic, and the electronic device can have better communication performance.

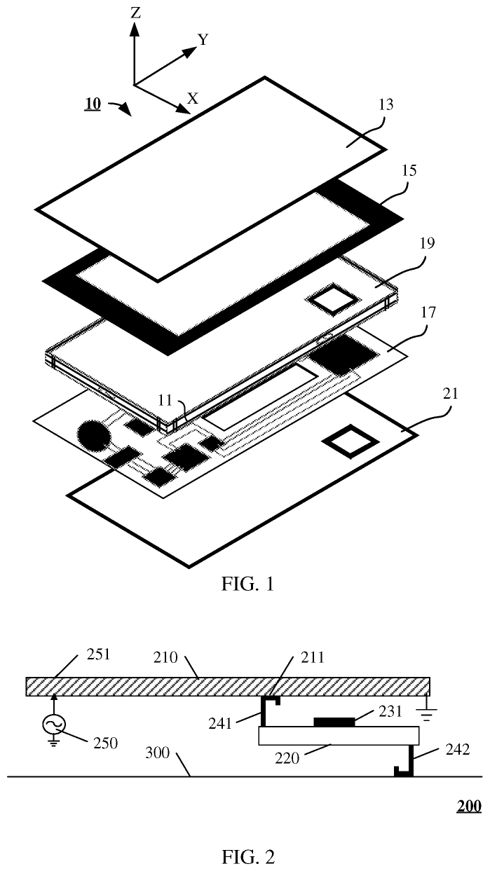

FIG. 2 is a diagram of an antenna 200 according to an embodiment of this application.

As shown in FIG. 2, the antenna 200 includes a radiator 210, a subboard 220, a first electronic element 231, a first connecting member 241, and a second connecting member 242.

The subboard 220 and the radiator 210 are opposite to and not in contact with each other; or the subboard 220 and the radiator 210 are spaced.

The radiator 210 includes a first connection point 211. A first end of the first connecting member 241 is electrically connected to the first connection point 211. A first end of the second connecting member 242 is electrically connected to a ground 300. In an embodiment, the first connecting member 241 may be a metal component like a metal spring. Connecting members in embodiments of this application may be correspondingly understood.

The first electronic element 231 is located on the subboard 230, and the first electronic element 231 is electrically connected between a second end of the first connecting member 241 and a second end of the second connecting member 242.

It should be understood that the radiator 210 is electrically connected to the ground 300 at the first connection point 211 via the first electronic element 231, so that when the radiator 210 generates a resonance, a current on the radiator 210 is shunted in an area near the first connection point 211. Because shunt occurs in the area near the first connection point 211, current density on the radiator 210 can be dispersed. In an embodiment, current distribution of the radiator 210 is scattered, to reduce a conductor loss of the radiator 210. In an embodiment, current distribution of the radiator 210 is scattered, to increase a radiation aperture of the radiator 210. Because the conductor loss of the radiator 210 is reduced, and a radiation aperture of the antenna 200 is increased, system efficiency and radiation efficiency of the antenna can be improved.

In an embodiment, the radiator 210 further includes a second connection point 212, and the radiator 210 is provided with a first slot between the first connection point 211 and the second connection point 212.

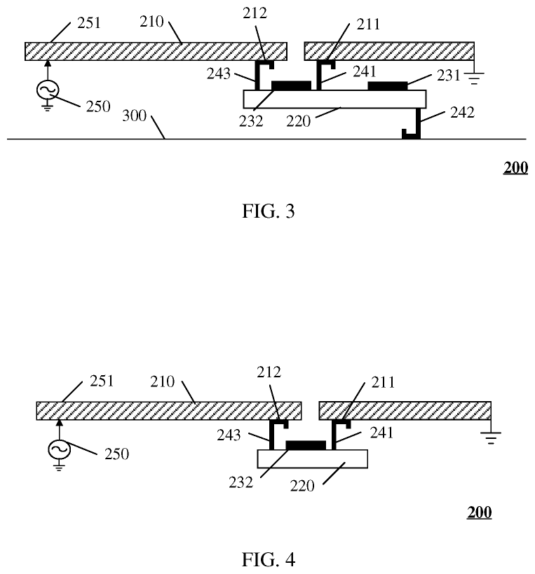

The antenna 200 further includes a third connecting member 243 and a second electronic element 232, as shown in FIG. 3. A first end of the third connecting member 243 is electrically connected to the second connection point 212. The second electronic element 232 is electrically connected between the second end of the first connecting member 241 and a second end of the third connecting member 243.

It should be understood that the radiator 210 is provided with the first slot. The first slot may be considered as an equivalent capacitor (for example, a distributed capacitor) disposed on the radiator 210. The equivalent capacitor may enable the radiator 210 to form a metamaterial structure. A radiation aperture of the radiator 210 in the metamaterial structure may be increased, and after the first slot is provided, an electric field is more dispersed, and a dielectric loss near a conductor is reduced. Therefore, the system efficiency and the radiation efficiency of the antenna 200 can be effectively improved.

In an embodiment, a distance between the first connection point 211 and/or the second connection point 212 and the first slot is less than or equal to 5 mm.

The distance between the first connection point 211/second connection point 212 and the first slot may be understood as a minimum distance between the first connection point 211/second connection point 212 and conductors on two sides of the first slot. When the first electronic element 231 is electrically connected to the first connection point 211 and the second connection point 212 via connecting members (for example, metal springs), the distance between the first connection point 211/second connection point 212 and the first slot may be understood as a minimum distance between a center of a part in which the connection point is in contact with the connecting member and the conductors on the two sides of the first slot.

It should be understood that an equivalent capacitance value of the first slot may be adjusted via the second electronic element 232 electrically connected between the first connection point 211 and the second connection point 212, to adjust a radiation characteristic (for example, a resonance point frequency) of the antenna 200.

In an embodiment, a width of the first slot is greater than or equal to 0.1 mm and less than or equal to 2 mm. It should be understood that, in this embodiment of this application, widths of provided slots may all fall within the foregoing range.

In an embodiment, a first end of the radiator 210 is a ground end, and a second end of the radiator is an open end.

It should be understood that, for brevity of description, in this embodiment of this application, only an example in which the first end of the radiator 210 is the ground end and the second end of the radiator is the open end is used for description. During actual application, both the first end and the second end of the radiator 210 may be open ends or ground ends. When the first end of the radiator 210 is the ground end and the second end of the radiator is the open end, an operating mode of the radiator 210 may be a quarter-wavelength mode. When both the first end and the second end of the radiator 210 may be the open ends or the ground ends, an operating mode of the radiator 210 may be a half-wavelength mode.

In an embodiment, a length of the radiator 210 between the first end (the ground end) of the radiator 210 and the first slot is less than a length of the radiator 210 between the second end (the open end) of the radiator 210 and the first slot.

It should be understood that a length of the radiator between one end of the radiator and the first slot may be understood as a length of a conductor part between an end part of the end and the first slot. For brevity of description, it may be correspondingly understood in this embodiment of this application.

In an embodiment, the length of the radiator 210 between the first end (the ground end) of the radiator 210 and the first slot is less than three-fifths of the length of the radiator 210 between the second end (the open end) of the radiator 210 and the first slot.

In an embodiment, the length of the radiator 210 between the first end (the ground end) of the radiator 210 and the first slot is less than one-third of the length of the radiator 210 between the second end (the open end) of the radiator 210 and the first slot.

In an embodiment, the length of the radiator 210 between the first end (the ground end) of the radiator 210 and the first slot is less than one-seventh of the length of the radiator 210 between the second end (the open end) of the radiator 210 and the first slot.

It should be understood that the first slot may be located in an area in which a current of the radiator 210 is large. The area with a large current should be understood as that in comparison with a radiator 210 (for example, operating in the quarter-wavelength mode) that is not slotted, after the first slot is provided, strength of an electric field of the radiator 210 is weakened, to disperse the electric field. This improves the system efficiency and the radiation efficiency of the antenna 200.

In an embodiment, the radiator 210 may be configured to generate a first resonance. An electrical length of the radiator 210 may be greater than three-eighths of a first wavelength, and the first wavelength may be a wavelength corresponding to the first resonance.

It should be understood that the first end of the radiator 210 is the ground end, and the second end of the radiator is the open end. The first resonance of the radiator 210 may correspond to the quarter-wavelength mode. The second electronic element 232 and the first slot may make the electrical length of the radiator 210 greater than three-eighths of the first wavelength. The current on the radiator 210 is codirectional (for example, a reversal does not occur), and an electric field between the radiator 210 and the ground is not reversed. The electrical length of the radiator 210 increases from a quarter of the first wavelength to more than three-eighths of the first wavelength, but the radiator 210 still operates in the quarter-wavelength mode. In this case, the current density on the radiator 210 is dispersed, and density of the electric field between the radiator 210 and the ground 300 is reduced, to reduce a conductor loss and a dielectric loss caused by the radiator 210 and a conductor and a dielectric disposed around the radiator 210, and further improve the radiation characteristic of the antenna 200.

In an embodiment, the first electronic element 231 may be a capacitor or an electronic element equivalent to a capacitor.

In an embodiment, an equivalent capacitance value of the first electronic element 231 may be less than or equal to a first threshold. The first threshold may be designed based on a resonance point frequency of the first resonance generated by the radiator 210. When the resonance point frequency of the first resonance is less than or equal to 1 GHZ, the first threshold is 10 picofarad (pF). When the resonance point frequency of the first resonance is greater than 1 GHz, the first threshold is 2 pF.

It should be understood that, an equivalent inductance value of the first electronic element 231 is designed based on different resonance point frequencies of the first resonance, so that current distribution on the radiator 210 is more even, the conductor loss and the dielectric loss are reduced, and the radiation aperture of the radiator 210 is increased, to improve radiation characteristics (for example, the radiation efficiency and the system efficiency) of the antenna.

In addition, the first electronic element 231 may be a lumped element, or may be a distributed element. A structure of the first electronic element 231 is not limited in embodiments of this application, and may be determined based on actual production or designs.

In an embodiment, the second electronic element 232 may include an inductor, a capacitor, and a 0-ohm resistor. In an embodiment, the second electronic element 232 may be configured to adjust the electrical length of the radiator 210, to adjust the radiation characteristic (for example, the resonance point frequency) of the antenna 200.

In an embodiment, the second electronic element 232 may be an inductor or an electronic element equivalent to an inductor.

In an embodiment, an equivalent inductance value of the second electronic element 232 may be less than or equal to 10 nanohenry (nH).

It should be understood that, an equivalent inductance value of the second electronic element 232 is designed based on different resonance point frequencies of the first resonance, so that current distribution on the radiator 210 is more dispersed, the conductor loss is reduced, and the radiation aperture of the radiator 210 is increased, to improve the radiation characteristics (for example, the radiation efficiency and the system efficiency) of the antenna.

In addition, the second electronic element 232 may be a lumped element, or may be a distributed element. When the second electronic element 232 is the distributed electronic element, the second electronic element 232 may be a metal wire (microstrip wire) disposed on a surface of the subboard. A structure of the second electronic element 232 is not limited in embodiments of this application, and may be determined based on actual production or designs.

In an embodiment, the antenna 200 may further include a feed circuit 250. The feed circuit 250 is coupled and connected to a feed point 251 of the radiator 210, and feeds an electrical signal into the radiator 210.

In an embodiment, a length of the radiator 210 between the feed point 251 and the first end (the ground end) of the radiator 210 is greater than a length of the radiator 210 between the feed point 251 and the second end (the open end) of the radiator 210.

It should be understood that an example in which the radiator 210 may form a structure similar to a left handed antenna, and operate in a quarter-wavelength mode of the left handed antenna is used for description. The left handed antenna may be, for example, an antenna that meets a composite left/right handed (composite right/left handed, CRLH) transmission line structure.

In an embodiment, a length of the radiator 210 between the feed point 251 and an end part of the second end of the radiator 210 is less than 5 mm, so that miniaturization of the antenna 200 is implemented.

In an embodiment, the radiator 210 may be in a form based on a flexible mainboard or flexible printed circuit (FPC), a form based on laser direct structuring (LDS), an antenna form based on a microstrip disk antenna (MDA), or the like.

It should be understood that, for brevity of description, in this embodiment of this application, only an example in which the conductive part of the side frame of the electronic device is used as the radiator is used for description. In an embodiment, when the radiator 210 is in the form based on the FPC or the LDS, the radiator 210 is located between the PCB and the rear cover of the electronic device, or the radiator 210 is located between the PCB and the display screen, or the radiator 210 is located on a support. This is not limited in this embodiment of this application.

FIG. 4 is a diagram of an antenna 200 according to an embodiment of this application.

As shown in FIG. 4, the antenna 200 includes the radiator 210, the subboard 220, the second electronic element 232, the first connecting member 241, and the third connecting member 243.

The subboard 220 and the radiator 210 are opposite to and not in contact with each other.

The radiator 210 includes the first connection point 211 and the second connection point 212. The first end of the first connecting member 241 is electrically connected to the first connection point 211. The first end of the third connecting member 243 is electrically connected to the second connection point 212. The second electronic element 232 is located on the subboard 230, and the second electronic element 232 is electrically connected between the second end of the first connecting member 241 and the second end of the third connecting member 243.

The radiator 210 is provided with the first slot between the first connection point 211 and the second connection point 212.

It should be understood that the radiator 210 is provided with the first slot. The first slot may be considered as the equivalent capacitor (for example, the distributed capacitor) disposed on the radiator 210. The equivalent capacitor may enable the radiator 210 to form the metamaterial structure. The radiation aperture of the radiator 210 in the metamaterial structure may be increased, and after the first slot is provided, the electric field is more dispersed, and the dielectric loss near the conductor is reduced. Therefore, the system efficiency and the radiation efficiency of the antenna 200 can be effectively improved.

A difference between the antenna 200 shown in FIG. 4 and the antenna 200 shown in FIG. 3 lies only in that the first electronic element is not disposed in the antenna 200 shown in FIG. 4. For brevity of description, parts similar to the antenna 200 shown in FIG. 3 and the antenna 200 shown in FIG. 4 are not described in detail, for example, the width of the first slot, the distance between the first connection point 211 and/or the second connection point 212 and the first slot, the length of the radiator 210 between the first end (for example, the ground end) of the radiator 210 and the first slot, a value range of the second electronic element 232, the electrical length of the radiator 210, and a form of the radiator 210.

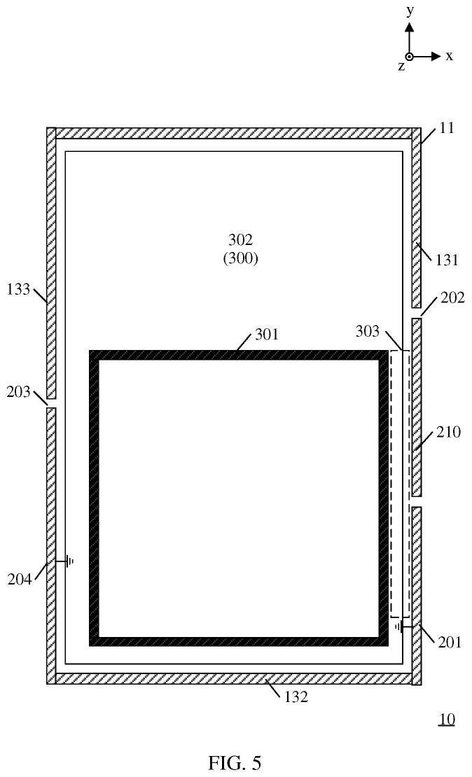

FIG. 5 is a diagram of an electronic device 10 according to an embodiment of this application.

As shown in FIG. 5, the electronic device 10 may include the side frame 11.

The side frame 11 includes a first location 201 and a second location 202. The side frame 11 is coupled and connected to the ground 300 at the first location 201, and a second slot is provided at the second location 202. A conductor part between the first location 201 and the second location 202 is used as the radiator 210 in the foregoing embodiment.

It should be understood that an example in which the electronic device 10 shown in FIG. 5 includes the structure of the antenna 200 shown in FIG. 3 is used for description. During actual application, the electronic device 10 may also include the structure of the antenna 200 shown in FIG. 2 or FIG. 4. For brevity of description, details are not described again.

In addition, in the electronic device 10 shown in FIG. 5, an example in which the first end (at the first location 201) of the radiator 210 is the ground end and the second end (at the second location 202) is the open end is used for description. During actual application, both the first end and the second end of the radiator 210 may be the open ends or the ground ends (the side frame 11 is provided with slots at the first location 201 and the second location 202 or is coupled and connected to the ground 300).

In an embodiment, the side frame 11 includes a first side 131 and a second side 132 that intersect at an angle, and a length of the first side 131 is greater than a length of the second side 132. In an embodiment, the first slot or the second slot is located on the first side 131, and a distance between the first slot or the second slot and a midpoint of the first side 131 is greater than 0 mm and less than or equal to 30 mm. Lengths of first sides 131 on two sides of the midpoint of the first side 131 are the same.

It should be understood that the first slot and the second slot do not overlap the midpoint of the first side 131, so that strength of the electronic device 10 can be improved.

In an embodiment, the side frame 11 includes a third side 133 and the second side 132 that intersect at an angle, and a length of the third side 133 is greater than the length of the second side 132. The side frame 11 is provided with a third slot on the third side 133, and a distance between the first slot or the second slot and the third slot in an extension direction (for example, a y direction) of the first side 131 is greater than 2 mm.

It should be understood that, the first slot and the second slot do not overlap the third slot in the extension direction (for example, the y direction) of the first side 131, so that the strength of the electronic device 10 can be improved. A distance between the first slot or the second slot and the third slot in the extension direction (for example, the y direction) of the first side 131 may be understood as a distance (a length of a conductor) between a projection of the third slot on the first side 131 and the first slot or the second slot.

In an embodiment, a distance between the third slot and a midpoint of the third side 133 is greater than 0 mm and less than or equal to 30 mm. It should be understood that the third slot does not overlap the midpoint of the third side 133, so that the strength of the electronic device 10 can be improved.

In an embodiment, the third side 133 may include a third location 203 and a fourth location 204. The side frame 11 may be provided with the third slot at the third location 203, and is coupled and connected to the ground 300 at the fourth location 204. A conductor part between the third location 203 and the fourth location 204 may be used as a radiator of another antenna. This is not limited in this embodiment of this application.

In an embodiment, the electronic device 10 includes the middle frame 19. The middle frame 19 includes a battery compartment 301 and a middle plate 302. The battery compartment 301 is located on the middle plate 302. The middle plate 302 may be used as the ground 300 in the foregoing embodiment. A battery of the electronic device 10 may be located in space enclosed by the battery compartment 301. In an embodiment, the side frame 11 is connected to the middle plate 302 via a connection rib structure. The connection rib structure (not shown in the figure) is connected between the side frame and the middle plate, and is integrated with the side frame and the middle plate. In an embodiment, the battery compartment 301, the middle plate 302, and the side frame 11 are integrated.

In an embodiment, a first part of the battery compartment 301 and the radiator 210 are opposite to and not in contact with each other. The first part of the battery compartment 301, the radiator 210, and the middle plate 302 form a groove 303, as shown in FIG. 5.

In an embodiment, the subboard 220 in the foregoing embodiment may be located in the groove enclosed by the first part of the battery compartment 301, the radiator 210, and the middle plate 302, as shown in FIG. 6.

In an embodiment, a distance D1 (for example, a width of the groove 303) between the first part of the battery compartment 301 and the radiator 210 is less than or equal to 3 mm.

It should be understood that the distance between the first part of the battery compartment 301 and the radiator 210 may be understood as a minimum value of a distance between a point on the first part and a point on the radiator 210, and the distance between the first part of the battery compartment 301 and the radiator 210 may also be understood as the width of the groove 303. In an embodiment, the distance between the first part of the battery compartment 301 and the radiator 210 may also be understood as a distance between the first part of the battery compartment 301 and the radiator 210 in a first direction. The first direction is a direction, for example, an x direction, perpendicular to an extension direction of the subboard 220.

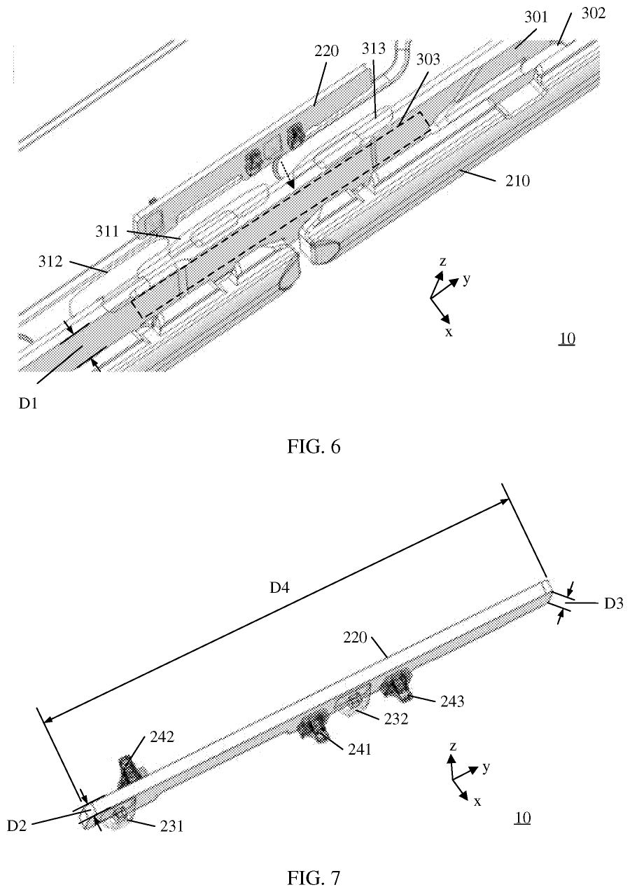

In an embodiment, the first electronic element 231 and the second electronic element 232 may be located on a first surface of the subboard 220, as shown in FIG. 7. The first surface of the subboard 220 is a surface facing the radiator. In an embodiment, the first electronic element 231 and the second electronic element 232 may be located on a second surface of the subboard 220. The second surface of the subboard 220 is a surface facing the battery compartment. In an embodiment, the first electronic element 231 and the second electronic element 232 may be respectively located on the first surface and the second surface of the subboard 220.

It should be understood that, for brevity of description, the antenna 200 shown in FIG. 6 is the antenna 200 shown in FIG. 3 (the antenna 200 includes the first electronic element 231 and the second electronic element 232). Any one of the antennas 200 in the foregoing embodiments may also be used during actual application. Embodiments shown in FIG. 5 and FIG. 6 impose no limitation thereto.

In addition, the first electronic element 231 and the second electronic element 232 may be lumped elements or distributed elements. This is not limited in embodiments of this application. For brevity of description, only the lumped elements are used as an example for description.

In an embodiment, the second end of the first connecting member 241 and the second end of the third connecting member 243 are connected to the first surface of the subboard 220.

In an embodiment, the second end of the second connecting member 242 is connected to the second surface of the subboard 220. The first surface and the second surface of the subboard 220 are surfaces disposed opposite to each other on the subboard 220. The first surface is a surface facing the radiator of the subboard 220, and the second surface is a surface facing the battery compartment of the subboard 220.

In an embodiment, a size D2 of the subboard 220 in the first direction (for example, the x direction) is less than or equal to 1 mm. In an embodiment, a size D2 of the subboard 220 in the first direction (for example, the x direction) is less than or equal to 0.5 mm.

In an embodiment, a size D3 of the subboard 220 in a second direction is less than or equal to 5 mm. The second direction is a thickness direction of the electronic device 10, for example, a z direction.

In an embodiment, a size D4 of the subboard 220 in a third direction is less than or equal to 30 mm. In an embodiment, a size D4 of the subboard 220 in a third direction is less than or equal to 20 mm. The third direction is an extension direction of the first side, for example, the y direction.

In an embodiment, the electronic device further includes a first metal member 311, a second metal member 312, and a third metal member 313, as shown in FIG. 6.

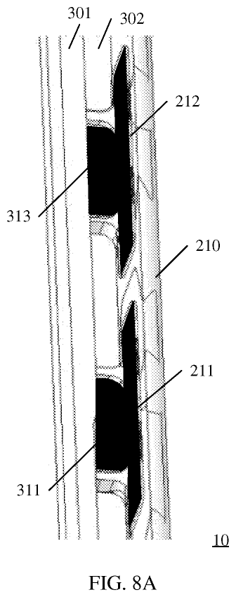

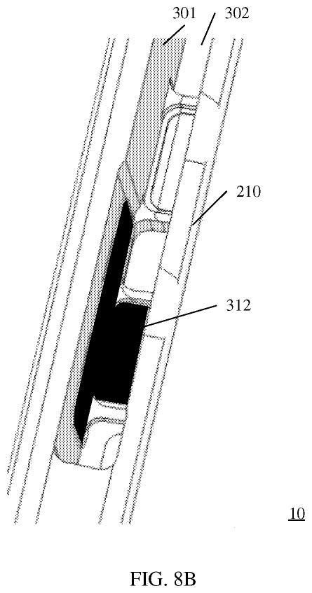

In an embodiment, the first metal member 311, the second metal member 312, and the third metal member 313 are located in the groove enclosed by the first part of the battery compartment 301, the radiator 210, and the middle plate 302, as shown in FIG. 8A and FIG. 8B.

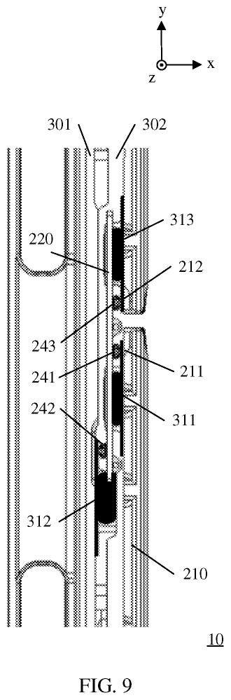

In an embodiment, a first part of the first metal member 311 is welded (for example, through spot welding) to the middle plate 302, and a first part of the third metal member 313 is welded (for example, through spot welding) to the middle plate 302, as shown in FIG. 8A. In an embodiment, a second part of the first metal member 311 is located between the first end of the first connecting member 241 and the first connection point 211, and a second part of the third metal member 313 is located between the first end of the third connecting member 243 and the second connection point 212, as shown in FIG. 9.

In an embodiment, a first part of the second metal member 312 is welded (for example, through spot welding) to the middle plate 302, as shown in FIG. 8B. In an embodiment, a second part of the second metal member 312 is located between the first end of the second connecting member 242 and the first part of the battery compartment 301, as shown in FIG. 9.

It should be understood that, because the width of the groove enclosed by the first part of the battery compartment 301, the radiator 210, and the middle plate 302 is narrow (for example, the distance D1 between the first part of the battery compartment 301 and the radiator 210 is less than or equal to 3 mm), the first metal member 311, the second metal member 312, and the third metal member 313 cannot be fastened to the first connection point 211, the battery compartment 301, and the second connection point 212 through welding (for example, spot welding). Therefore, in the foregoing technical solution, the first metal member 311, the second metal member 312, and the third metal member 313 may be welded (for example, through spot welding) to the middle plate 302, so that same technical effect can also be achieved and implementation is more convenient.

In an embodiment, the first metal member 311, the second metal member 312, and the third metal member 313 may be springs. The first end of the first connecting member 241 is elastically connected to the second part of the first metal member 311. The first end of the second connecting member 242 is elastically connected to the second part of the second metal member 312. The first end of the third connecting member 243 is elastically connected to the second part of the third metal member 313.

It should be understood that a connecting member may fasten a second part of a corresponding metal member between a first end of the connecting member and a connection point in an elastic connection manner.

In an embodiment, conductivity of the first metal member 311, the second metal member 312, or the third metal member 313 may be greater than conductivity of the conductor part (for example, the radiator 210) of the side frame, the battery compartment 301, or the middle plate 302, to improve conductivity effect between the subboard 220 and the radiator 210 or the battery compartment 301, and improve stability of an electrical connection.

In an embodiment, the conductor part (for example, the radiator 210) of the side frame, the battery compartment 301, or the middle plate 302 of the electronic device 10 may be aluminum alloy. In an embodiment, the first metal member 311, the second metal member 312, or the third metal member 313 may be copper or gold-plated copper.

It should be understood that, compared with copper or gold-plated copper, corrosion resistance of aluminum alloy is poor, and an electrical connection of the first end of the connecting member is unstable due to long-time use. The first metal member 311, the second metal member 312, or the third metal member 313 can improve stability of the electrical connection, and avoid radiation spurious emission (RSE) caused by the unstable electrical connection.

In addition, when the antenna 200 is the antenna 200 shown in FIG. 2, the electronic device 10 may include only the first metal member 311 and the second metal member 312. For brevity of description, details are not described again.

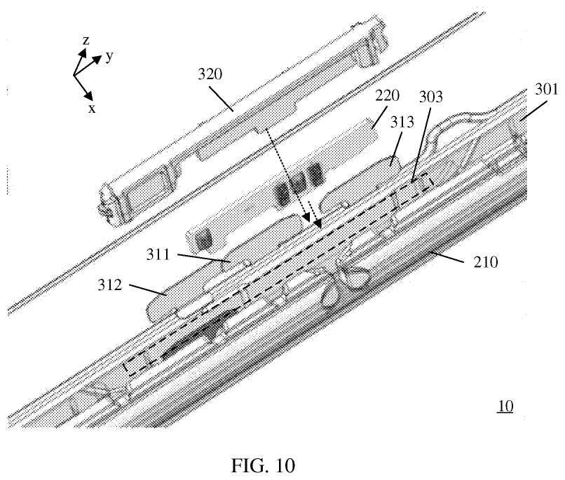

In an embodiment, the electronic device 10 may further include a limiting member 320, as shown in FIG. 10. The limiting member 320, the first part of the battery compartment 301, the radiator 210, and the middle plate may form enclosed space.

It should be understood that, in the electronic device 10 shown in FIG. 10, the limiting member 320 may be configured to limit the subboard 220 to be located in the enclosed space, to prevent the subboard 220 from sliding (for example, sliding in the y direction) in the groove 303.

The foregoing descriptions are merely implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An electronic device, comprising:
a ground; and
an antenna, the antenna comprising:
a radiator;
a subboard;
a first electronic element;
a first connecting member; and
a second connecting member;
the subboard and the radiator are opposite to and not in contact with each other;
the radiator comprises a first connection point and a second connection point, a first end of the first connecting member is electrically connected to the first connection point, and a first end of the second connecting member is electrically connected to the second connection point;
the first electronic element is located on the subboard, and the first electronic element is electrically connected between a second end of the first connecting member and a second end of the second connecting member; and
the radiator is provided with a first slot between the first connection point and the second connection point.

2. The electronic device of claim 1, wherein the antenna further comprises a third connecting member and a second electronic element, a first end of the third connecting member is electrically connected to the ground, the second electronic element is located on the subboard, and the second electronic element is electrically connected between the second end of the first connecting member and a second end of the third connecting member.

3. The electronic device of claim 1, wherein:
the electronic device further comprises a side frame, the side frame comprises a first location and a second location, the side frame is coupled and connected to the ground at the first location, and the side frame is provided with a second slot at the second location; and
the radiator is a conductor part of the side frame between the first location and the second location.

4. The electronic device of claim 3, wherein:
the electronic device further comprises a middle frame and a battery, the middle frame comprises a battery compartment and a middle plate, the battery is located in space enclosed by the battery compartment, the battery compartment is located on the middle plate, and the middle plate is used as the ground; and
the subboard is located in a groove enclosed by a first part of the battery compartment, the radiator, and the middle plate.

5. The electronic device of claim 4, wherein:
the electronic device further comprises a first metal member, a second metal member, and a third metal member;
the first metal member, the second metal member, and the third metal member are located in the groove;
a first part of the first metal member is welded to the middle plate, and a second part of the first metal member is located between the first end of the first connecting member and the first connection point;
a first part of the second metal member is welded to the middle plate, and a second part of the second metal member is located between the first end of the second connecting member and the second connection point; and
a first part of the third metal member is welded to the middle plate, and a second part of the third metal member is located between the first end of the third connecting member and the first part of the battery compartment.

6. The electronic device of claim 5, wherein:
the first metal member, the second metal member, and the third metal member are springs; and
the first end of the first connecting member is elastically connected to the second part of the first metal member, the first end of the second connecting member is elastically connected to the second part of the second metal member, and the first end of the third connecting member is elastically connected to the second part of the third metal member.

7. The electronic device of claim 4, wherein:
the electronic device further comprises a limiting member, and the limiting member, the first part of the battery compartment, the radiator, and the middle plate form enclosed space.

8. The electronic device of claim 1, wherein:
the first electronic element is located on a first surface or a second surface of the subboard, the first surface faces the radiator, and the second surface faces the battery compartment; and
the second electronic element is located on the first surface or the second surface.

9. The electronic device of claim 4, wherein a distance between the first part of the battery compartment and the radiator is less than or equal to 3 millimeters (mm).

10. The electronic device of claim 3, wherein a length of a conductor part between the first location and the first slot is less than a length of a conductor part between the second location and the first slot.

11. The electronic device of claim 3, wherein the length of the conductor part between the first location and the first slot is less than three-fifths of the length of the conductor part between the second location and the first slot.

12. The electronic device of claim 3, wherein:
the side frame comprises a first side and a second side that intersect at an angle, and a length of the first side is greater than a length of the second side; and
the first slot is located on the first side, and a distance between the first slot and a midpoint of the first side is greater than 0 mm and less than or equal to 30 mm.

13. The electronic device of claim 3, wherein:
the side frame comprises the first side and a third side that intersect with the second side at an angle, lengths of the first side and the third side are greater than the length of the second side, and the first slot or the second slot is located on the first side; and
the side frame is provided with a third slot on the third side, a distance between the first slot or the second slot and the third slot in a first direction is greater than or equal to 2 mm, and the first direction is an extension direction of the first side.

14. The electronic device of claim 13, wherein a distance between the third slot and a midpoint of the third side is greater than 0 mm and less than or equal to 30 mm.

15. The electronic device of claim 2, wherein:
a length of a radiator between the first connection point and the first slot is less than or equal to 5 mm; and/or
a length of a radiator between the second connection point and the first slot is less than or equal to 5 mm.

16. The electronic device of claim 1, wherein a size of the subboard in a second direction is less than or equal to 1 mm, a size of the subboard in a third direction is less than or equal to 5 mm, the second direction is perpendicular to an extension direction of the subboard, and the third direction is a thickness direction of the electronic device.

17. An electronic device, comprising:
a ground; and
an antenna, the antenna comprising:
a radiator;
a subboard;
a first electronic element;
a first connecting member; and
a second connecting member;
the subboard and the radiator are opposite to and not in contact with each other;
the radiator comprises a first connection point, a first end of the first connecting member is electrically connected to the first connection point, and a first end of the second connecting member is electrically connected to the ground;
the first electronic element is electrically connected between a second end of the first connecting member and a second end of the second connecting member; and
the first electronic element is located on a first surface or a second surface of the subboard, the first surface faces the radiator, and the second surface is opposite to the first surface.

18. The electronic device of claim 17, wherein:
the electronic device further comprises a side frame, the side frame comprises a first location and a second location, the side frame is coupled and connected to the ground at the first location, and the side frame is provided with a first slot at the second location; and
the radiator is a conductor part of the side frame between the first location and the second location.

19. The electronic device of claim 18, wherein:
the electronic device further comprises a middle frame and a battery, the middle frame comprises a battery compartment and a middle plate, the battery is located in space enclosed by the battery compartment, the battery compartment is located on the middle plate, and the middle plate is used as the ground; and
the subboard is located in a groove enclosed by a first part of the battery compartment, the radiator, and the middle plate.

20. The electronic device of claim 19, wherein:
the electronic device further comprises a first metal member and a second metal member;
the first metal member and the second metal member are located in the groove;
a first part of the first metal member is welded to the middle plate, and a second part of the first metal member is located between the first end of the first connecting member and the first connection point; and
a first part of the second metal member is welded to the middle plate, and a second part of the second metal member is located between the first end of the second connecting member and the first part of the battery compartment.
